(19) United States
(12) Patent Application Publication
(10) Pub. No.: US 2007/0023466 A1
(43) Pub. Date: Feb. 1, 2007

(54) Removable article carrier for a golf cart

(76) Inventor: Steven A. Policastro, Wildwood, FL (US)

Correspondence Address: MCKAY & ASSOCIATES, PC., 801 MCNEILLY ROAD, PITTSBURG, PA, 15226, US

(21) Appl. No.: 11/281,999

(22) Filed: Nov. 17, 2005

Related U.S. Application Data
(60) Provisional application No. 60/703,212, filed on Jul. 28, 2005.

(51) Int. Cl. B60R 7/00; B60R 9/00; B60R 11/00; B62B 3/00

(52) U.S. Cl. 224/42.39; 280/646; 224/274; 224/525

(57) ABSTRACT

The invention is a removable golf cart rack for carrying articles. The article carrier includes a support rack configured to slide over a rounded base and be held in place by gravity with the base situated between horizontal bars of the article carrier. In use, the article carrier can be easily situated on the base. During non-use, the article carrier is simply lifted off of the base, providing an aesthetically pleasing and safer alternative to typical racks mounted to golf carts using hardware.

This application claims the benefit of provisional application Ser. No. 60/703,212 filed Jul. 28, 2005.

### BACKGROUND

1. Field of the Invention

The present invention relates to article carriers disposed at the rear of golf carts. Particularly, the invention described herein is a golf cart-mountable rack for carrying golf bags or other articles, wherein the shelf-like carrier can be easily removed from a base to safely and aesthetically allow the golf cart to be used for everyday activities when the carrier is not needed.

2. Description of the Related Art

Known in the art are golf bag holding devices which are mounted to the rear of golf carts. There exist a variety of golf bag racks and trailer devices which are either attachable to vehicle hitches, or attachable and detachable directly at the rear of the golf cart, for instance by being bolted directly to the cart. The article carriers obviously facilitate the transportation of articles such as golf bags should a golfer choose to use a golf cart on a golf course instead of walking and carrying a bag.

In contrast to their typical use as golfer aids, golf carts are prevalent and are the sole means of transportation in what are commonly referred to as golf-cart communities, such as in areas of Florida and Arizona in the United States of America. Local residents and others rely on golf carts instead of full-size motor vehicles for everyday activities, and in some instances, large motor vehicles are even prohibited. For instance such activities may not only be golf, but may also be travel to the grocery store and other events.

There is a need for an article-carrying assembly which can not only be used for transporting a variety of articles, including golf bags, but which also can easily be removed when not necessary. The bulky metal components of typical racks and holders can be sharp and intrusive, and they further can add unsafe weight to the vehicles. For everyday use, it would be beneficial if the article carrier portion of the golf cart rack could be simply lifted and slid away from the cart when the carrier is not needed. Accidental contact and resulting injury to a person and/or harm to clothing can occur when a passer-by brushes by the bulky, sharp portions of the carrier. The present configuration enhances the safety and also the aesthetic appearance of the golf cart, and further allows the carrier to be re-attached without the use of additional hardware, thereby easing the assembly and disassembly before or after a golf event. The present invention further retains the articles being carried from the rear of the golf cart and not directly on the golf cart floor, allowing more space for rear-seated passengers in four-person golf carts.

### SUMMARY OF THE INVENTION

Accordingly, what is provided is a removable article carrier for a golf cart, comprising a support rack having parallel, vertical rack arms which join to form a rounded rack top adapted to situate on the rounded top of a base. A horizontal distal bar is attached at the rear edges of the rack arms near the rounded top of the support rack; a horizontal medial bar is medially attached at the front edges of the rack arms, and a horizontal proximal bar is attached at the rear edges of the rack arms near the bottom of the support rack; wherein the article carrier may be slid over the top of the base such that the vertical members and rounded top of the base slide over the proximal bar, under the medial bar, then over the distal bar to removably hold the article carrier in place on the base by gravity. To remove the article carrier, the article carrier can simply be lifted upward and off of the base, leaving only the base attached to the golf cart.

A horizontal crossbar is attached to the support rack of the article carrier, to which a bag holding apparatus may be attached. The article carrier further includes a shelf attached at the bottom thereof which allows articles such as golf bags to be situated thereon and then strapped to the article carrier using the straps of the bag holding apparatus.

### BRIEF DESCRIPTION OF THE DRAWINGS

FIG. 1 shows a perspective view of the typical base.

FIG. 2 shows a perspective view showing the base mounted to the underside of the golf cart.

FIG. 3 shows a perspective view of the article carrier.

FIG. 3a shows a perspective view of the article carrier being placed onto the attached base on the golf cart.

FIG. 4 shows a top view of the shelf of the article carrier.

FIG. 5 shows a bottom view of the shelf of the article carrier.

FIG. 6 shows a front view of the article carrier.

FIG. 7 shows a side view of the article carrier.

FIG. 8 shows a perspective view of the bag holder attachable to the support rack of the article carrier.

FIG. 9 shows a top view of the bag holder.

FIG. 10 shows a perspective view of the article carrier in use on the base as the entire rack assembly is fixed to the golf cart.

### DETAILED DESCRIPTION OF THE PREFERRED EMBODIMENT

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated method, and such further applications of the principles of the invention illustrated herein, as would normally occur to persons skilled in the art to which the invention relates.

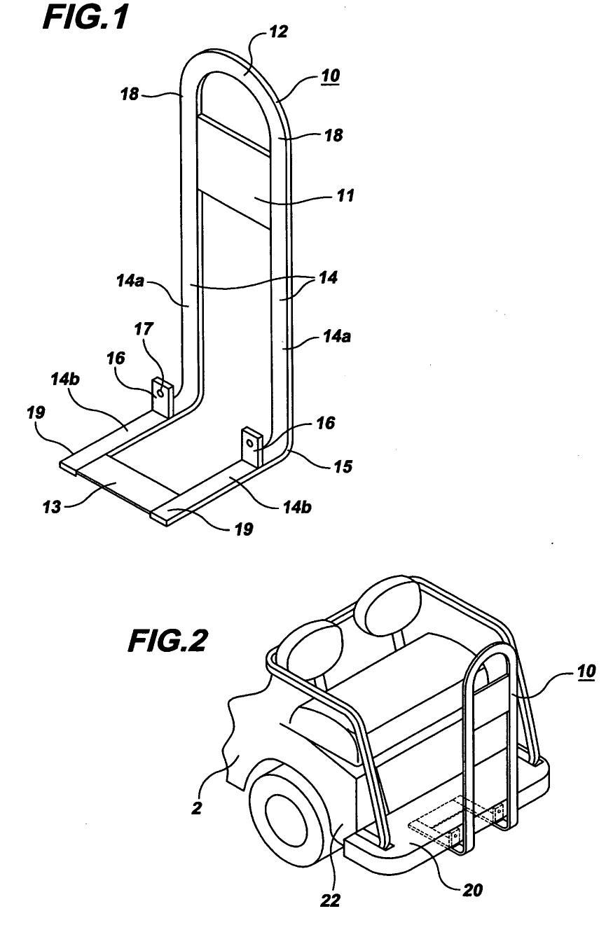

With reference then to FIGS. 1 and 2, shown is the base 10. Similar to the shape of a horseshoe, the base 10 has a pair of parallel, vertical members 14a which curve and join at their distal ends 18 to form a rounded top 12. Integrally formed to the vertical members 14a are the horizontal members 14b. As termed herein, the horizontal members 14b and vertical members 14a make up the L-shaped arms 14 of the base 10. The L-shaped arms 14 can be held more rigid by using a rigid support plate 13 fixed near the proximal ends 19 of the horizontal members 14b, and/or by also including a rigid base plate 11 connected to the vertical members 14a.

A mounting bracket 16 is fixed to each of the horizontal members 14b, preferably near the transition point 15 from horizontal to vertical, although the exact location may vary depending on the design of the golf cart 2. The mounting brackets 16 facilitate the attachment of the base 10 to the golf cart 2 underbody. For instance, bolts (not shown) may be inserted through holes 17 of the mounting brackets 16, and the base 10 can be bolted underneath the rear 22 of the golf cart 2 near the bumper 20 (see FIG. 2). If not bolted directly to the bumper 20, it is typical for there to be accommodating metal components underneath the rear of the golf cart for allowing the base 10 to be attached thereto in similar fashion. It is also fairly typical for the base 10 to come pre-installed with the golf cart 2. In use then, base 10 is fixed to the golf cart 2 to be upstanding from the golf cart bumper 20.

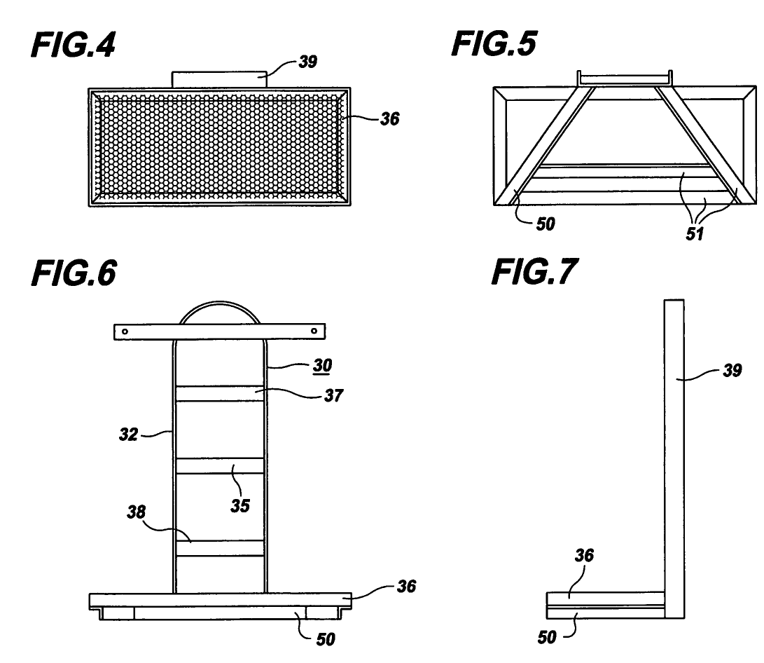

With reference then to FIGS. 1-10, the article carrier 3 includes a support rack 30 made up of a pair of rigid, parallel rack arms 32. Similar to the base 10, the rack arms 32 curve and join to form a rounded rack top 39. The rack arms 32 have a rack arm front edge 34 and a rack arm rear edge 33.

A shelf 36 is fixed to the bottom of the support rack 30. Shown in this embodiment and not limited thereto, the shelf 36 is generally rectangular with its surface comprising an aluminum grate. The grate can be made out of other materials, other than aluminum. The shelf 36 acts as a means for situating the bottom of articles such as grocery bags or golf bags thereon. The shelf underside 50 may include additional supporting means such as metal beams 51. As shown, metal beams 51 are arranged on the underside 50 of shelf 36 about the perimeter of underside 50 and also angularly spanning a width of the underside 50. The supporting means may also be arranged in any other manner depending on weight and supporting needs, such as by using a criss-cross configuration or generally linear configuration (not shown).

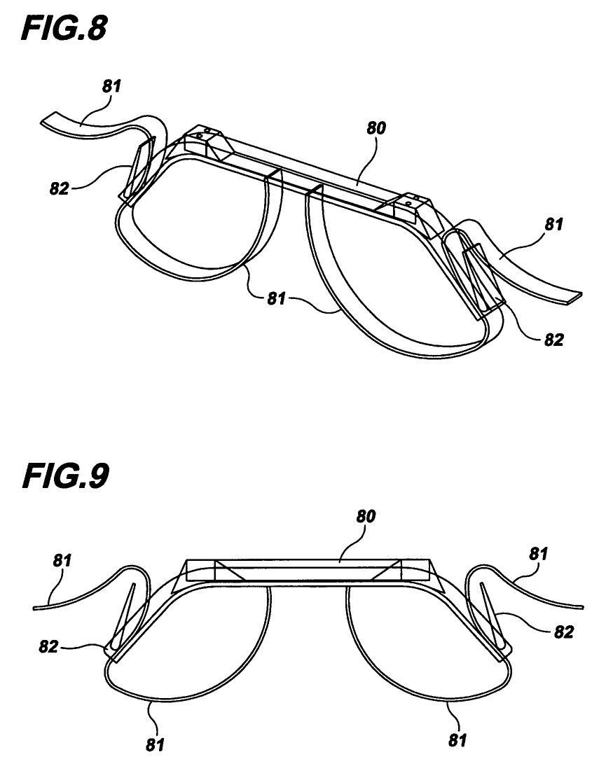

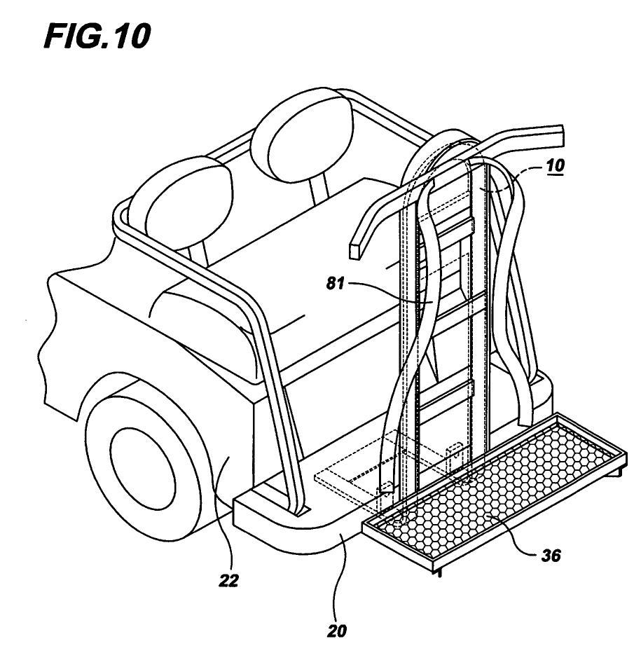

Any articles may further be secured to the article carrier 3 and/or shelf 36 by means of the cross bar 31. The cross bar 31 is a horizontal bar attached to the support rack 30 near the rack top 39. The crossbar 31 can have attached thereto any means for securing the top portions of articles, such as golf bags. Such means may include the strap assembly shown in FIGS. 8 and 9 for example. This bag holder 80 generally contains straps 81 which can be buckled down using buckles 82 after encircling a golf bag or other article. The bag holder 80 can be attached by being screwed or bolted to the crossbar for example. The crossbar 31 is also suited to aid in the placement and removal of the article carrier 3 when no other handle means are included on the article carrier 3.

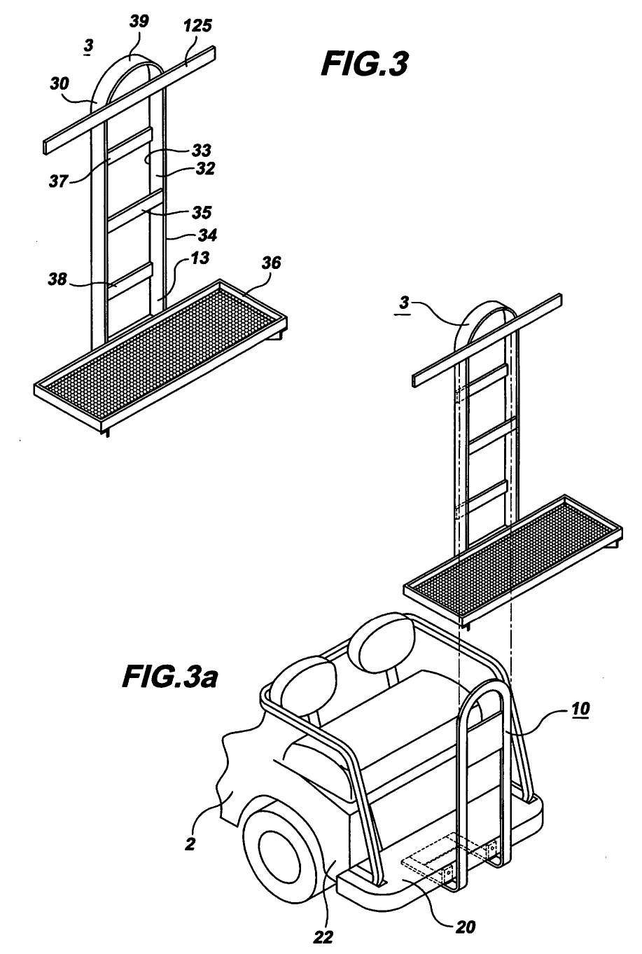

Further on the article carrier 3 and with reference particularly to FIGS. 3 and 6, a horizontal distal bar 37 spans the width formed by the rack arms 32 and is perpendicularly fixed to the rack arm rear edge 33 (or at slight angles if decoratively desired), proximate to the rack top 39. A medial bar 35 also spans the width formed by the rack arms 32 and is horizontally displaced perpendicular to the rack arms 32. However, the medial bar 35 is fixed to the rack arm front edge 34 as opposed to the rear edge 33, and it is generally medially situated along the rack arms 32. A horizontal proximal bar 38 is horizontally situated near the bottom of the rack arms 32 and fixed to the rack arm rear edge 33 in similar position as the distal bar 37. As a result of this configuration, the support rack 30 can be retained on base 10 by gravity. The article carrier 3 is retained on base 10 with the vertical members 14a of base 10 situated between the bars, as follows.

In use then, base 10 is bolted or otherwise mounted to the underside of the golf cart 2, near the rear bumper 20. The article carrier 3, with or without the bag holder 80 (depending on what is being carried), is then lifted up over the rounded top 12 of base 10 and the base 10 is allowed to penetrate into the support rack 30, passing over the proximal bar 38, under the medial bar, then over the distal bar 37 until the rack top 39 of the article carrier 3 rests in an unattached manner on the rounded top 12 of base 10. By being unattached but still retained on the base 10 by gravity during use, the article carrier 3 can subsequently be lifted off and removed from the base when not needed. Although not shown, a handle, strap, angle brace, or other type of attachment may be mounted to the article carrier 3 to aid in the removal and attachment of the article carrier 3 to the base 10. For example a handle or strap may be positioned on the side of the article carrier 3 or a rigid, angular brace may be fixed between the support rack 30 and shelf 36.

Without the article carrier 3, golf cart weight is minimized, and importantly, only the slim rounded base is exposed at the rear of the golf cart 2 instead of the bulky, sharp-cornered and sharp-edged portions of the article carrier 3, resulting in both an aesthetically pleasing appearance of the golf cart 2 and a safer rear end 22. Additionally, and as shown in FIG. 10, the present invention retains the carried articles off the rear 22 of the golf cart 2 and not directly on the golf cart floor, allowing more space for rear-seated passengers in four-person golf carts.

I claim:

1. A golf cart rack for carrying articles, comprising:
an article carrier configured to be removably positioned over a rounded top of an upstanding base, said article carrier further comprising;
a support rack including parallel, vertical rack arms, said vertical rack arms join to form a rounded rack top adapted to situate on said rounded top of said base; said vertical rack arms further having rear edges and front edges;
a distal bar spanning a width formed by said vertical rack arms and attached at said rear edges of said rack arms near said rounded rack top;
a medial bar spanning said width and medially attached at said front edges of said rack arms; and,
a proximal bar spanning said width and attached at said rear edges near a bottom of said support rack, wherein said article carrier can be removably held in place by gravity on said base with said vertical members of said base situated respectively between said distal bar, said medial bar, and said proximal bar.

2. The golf cart rack of claim 1, further comprising a horizontal crossbar attached to said support rack of said article carrier.

3. The golf cart rack of claim 1, further comprising a shelf attached to said article carrier near a bottom thereof.

4. A golf cart rack for carrying articles, comprising:
an article carrier configured to be removably positioned over a base, said article carrier further comprising;
a support rack including parallel, vertical rack arms, said vertical rack arms join to form a rounded rack top adapted to situate on said base;
a crossbar attached to said support rack near a top thereof; and,
a shelf attached to said support rack of said article carrier near a bottom thereof oriented away from said golf cart for allowing a bottom of a golf bag to be situated thereon, wherein said golf bag is retained off the rear of said golf cart instead of directly on the floor of said golf cart.

5. The golf cart rack of claim 4, wherein said article carrier further comprises a horizontal distal bar attached at rear edges of said rack arms near said rounded rack top; a horizontal medial bar medially attached at front edges of said rack arms; and a horizontal proximal bar attached at said rear edges near a bottom of said support rack.

6. The golf cart rack of claim 4, wherein said shelf includes a generally rectangular, grate-like surface.

7. The golf cart rack of claim 6, wherein an underside of said shelf includes additional supporting means.

8. The golf cart rack of claim 7, wherein said supporting means comprises metal beams arranged on said underside about the perimeter thereof angularly spanning a width of said underside.

9. A golf cart rack for carrying articles, comprising:
an article carrier configured to be removably positioned over a rounded top of an upstanding base, said article carrier further comprising;
a support rack including parallel, vertical rack arms, said vertical rack arms join to form a rounded rack top adapted to situate on said rounded top of said base; said vertical rack arms further having rear edges and front edges;
a distal bar spanning a width formed by said vertical rack arms and attached at said rear edges of said rack arms near said rounded rack top;
a medial bar spanning said width and medially attached at said front edges of said rack arms;
a proximal bar spanning said width and attached at said rear edges near a bottom of said support rack, wherein said article carrier can be removably held in place by gravity on said base with said vertical members of said base situated respectively between said distal bar, said medial bar, and said proximal bar;
a crossbar attached to said support rack near a top thereof; and,
a shelf attached to said support rack of said article carrier near a bottom thereof oriented away from said golf cart.
